(19) United States
(12) Patent Application Publication
(10) Pub. No.: US 2025/0232042 A1
(43) Pub. Date: Jul. 17, 2025

(54) VULNERABILITY RATING ENGINE

(71) Applicant: Armis Security Ltd., Tel Aviv-Jaffa (IL)

(72) Inventors: Elad Ben Akoune, Tel Aviv (IL); Roy Berland, Tel Aviv (IL); Tal Peled, Tel Aviv (IL)

(73) Assignee: Armis Security Ltd., Tel Aviv-Jaffa (IL)

(21) Appl. No.: 19/030,368

(22) Filed: Jan. 17, 2025

Related U.S. Application Data
(60) Provisional application No. 63/622,041, filed on Jan. 17, 2024.

(51) Int. Cl. G06F 21/57; G06F 21/55; G06F 21/56

(52) U.S. Cl. CPC G06F 21/577; G06F 21/552; G06F 21/566

(57) ABSTRACT

The present disclosure relates to systems and methods for determining comprehensive and asset vulnerability ratings using models such as artificial intelligence (AI) and machine learning (ML) models. These models can identify relevant attributes, optimize attribute values, and determine logical relationships between attributes. The term “model” encompasses various types of AI and ML models, including neural networks, language models, multimodal models, and others. Models can be trained using supervised learning with labeled data to predict or classify new data items. The models can be locally hosted, cloud-managed, or accessed via APIs, and can be implemented in electronic hardware such as computer processors.

### RELATED APPLICATIONS

The present application claims the benefit under 35 U.S.C. § 119(e) of U.S. Provisional Application No. 63/622,041, filed Jan. 17, 2024, which is hereby incorporated herein by reference in its entirety under 37 C.F.R. § 1.57. Any and all applications for which a foreign or domestic priority claim is identified in the Application Data Sheet as filed with the present application are hereby incorporated by reference under 37 C.F.R. § 1.57.

### TECHNICAL FIELD

This application is directed to approaches for assessing vulnerabilities in computing environments.

### BACKGROUND

The approaches described in this section are approaches that could be pursued, but not necessarily approaches that have been previously conceived or pursued. Thus, unless otherwise indicated, it should not be assumed that any of the material described in this section qualifies as prior art merely by virtue of its inclusion in this section.

It can be significant to identify cybersecurity threats and to take measures to mitigate cybersecurity threats. However, current approaches for identifying threats and prioritizing mitigation actions have several deficiencies. Accordingly, improved approaches are needed.

### BRIEF DESCRIPTION OF THE DRAWINGS

These and other features, aspects, and advantages of the present disclosure are described with reference to drawings of certain embodiments, which are intended to illustrate, but not to limit, the present disclosure. It is to be understood that the attached drawings are for the purpose of illustrating concepts disclosed in the present disclosure and may not be to scale.

FIG. 1 depicts an example of a process in a flow diagram for training an artificial intelligence or machine learning model according to some implementations.

FIG. 2 is a diagram that illustrates an example process for determining comprehensive vulnerating ratings according to some implementations.

FIG. 3 illustrates an example process for determining comprehensive vulnerability ratings and identifying affected assets according to some implementations.

FIG. 4 is a diagram that illustrates an example process for training a machine learning model to determine comprehensive vulnerability ratings and using said model to determine comprehensive vulnerability ratings according to some implementations.

FIG. 5 illustrates an example process for determining asset vulnerability ratings according to some implementations.

FIG. 6 is a block diagram illustrating an example process determining asset vulnerability ratings according to some implementations.

FIG. 7 illustrates an example user interface that can be used to define and/or customize one or more policies according to some implementations.

FIG. 8 is a block diagram depicting an embodiment of a computer hardware system configured to run software for implementing for implemented one or more of the systems and methods described herein.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### SUMMARY

For purposes of this summary, certain aspects, advantages, and novel features of the invention are described herein. It is to be understood that not all such advantages necessarily may be achieved in accordance with any particular implementation of the invention. Thus, for example, those skilled in the art will recognize that the invention may be embodied or carried out in a manner that achieves one advantage or group of advantages as taught herein without necessarily achieving other advantages as may be taught or suggested herein.

Some implementations herein are directed to a comprehensive vulnerability rating system comprising: at least one hardware processor; and at least one non-transitory memory storing instructions, which, when executed by the at least one hardware processor, cause the system to: receive and normalize a dataset to generate a normalized dataset, wherein normalizing the dataset comprises encoding categorical data and nominal data of the dataset; generate a training dataset from the normalized dataset, wherein the training dataset comprises training attributes used to generate a pre-determined comprehensive vulnerability rating associated with the training dataset; train a machine learning model by inputting the training dataset to the machine learning model to generate a trained machine learning model; evaluate the trained machine learning model using one or more evaluation criteria, wherein the one or more evaluation criteria comprise at least determining if an output of the machine learning model is within a threshold range of the pre-determined comprehensive vulnerability rating associated with the training dataset; receive and normalize an inference dataset to generate a normalized inference dataset, wherein the inference dataset comprises information associated with at least one vulnerability; generate one or more feature vectors from the normalized inference dataset; input the one or more feature vectors to the trained machine learning model to generate a comprehensive vulnerability rating associated with the at least one vulnerability associated with the normalized inference dataset; receive computing system data, the computing system data comprising information associated with a plurality of computer devices; identify, based on the comprehensive vulnerability rating associated with the at least one vulnerability associated with the normalized inference dataset, at least one computer device of the plurality of computer devices that is affected by the at least one vulnerability; and display, via a user interface, the comprehensive vulnerability rating associated with the at least one vulnerability and the identified at least one computing device affected by the at least one vulnerability.

In some implementations, the system is further caused to extract features from the inference dataset using a large language model (LLM) to generate the normalized inference dataset.

In some implementations, generating the comprehensive vulnerability rating associated with the at least one vulnerability of the normalized inference dataset comprises determining a plurality of attributes associated with the at least one vulnerability and at least one or more logical relationships between the plurality of attributes. In some implementations, the plurality of attributes comprise at least one of the following: most recent exploitation date, number of threat actors, nationalities of threat actors, number of exploits, number of exploit codes, whether or not the at least one vulnerability has been weaponized, whether or not botnets are used to exploit the at least one vulnerability, whether or not the at least one vulnerability is associated with ransomware, a likelihood that the at least one vulnerability will be exploited in the near future, whether or not the at least one vulnerability has been reported by one or more tracking services, social media activity related to the at least one vulnerability, news reports related to the at least one vulnerability, particular types of malware associated with the at least one vulnerability, when the at least one vulnerability was first weaponized, when an exploit for the at least one vulnerability was first published, and whether or not a patch is available for the at least one vulnerability. In some implementations, the system is further caused to determine a value associated with each of the plurality of attributes.

In some implementations, the machine learning model comprises a neural network. In some implementations, the machine learning model comprises a support vector machine algorithm, decision tree, Parzen window, Bayesian model, clustering model, reinforcement learning model, probability distribution, or decision tree forest. In some implementations, the machine learning model is locally hosted, cloud managed, accessed via one or more Application Programming Interfaces (“APIs”), or a combination of the above.

In some implementations, the system is further caused to determine a score for each of the one or more feature vectors, wherein the score corresponds to a contribution of the feature vector to the comprehensive vulnerability rating associated with the at least one vulnerability of the normalized inference dataset.

In some implementations, the generating the one or more feature vectors from the normalized inference dataset comprises determining a variance of one or more features of the normalized inference dataset and removing at least one of the one or more features that have a determined variance above a pre-determined threshold.

Some implementations herein are directed to a computer-implemented method for generating a comprehensive vulnerability rating associated with at least one vulnerability, the computer implemented method comprising: receiving and normalizing, by a computer system, a dataset to generate a normalized dataset, wherein normalizing the dataset comprises encoding categorical data and nominal data of the dataset; generating, by the computer system, a training dataset from the normalized dataset, wherein the training dataset comprises training attributes used to generate a pre-determined comprehensive vulnerability rating associated with the training dataset; training, by the computer system, a machine learning model by inputting the training dataset to the machine learning model to generate a trained machine learning model; evaluating, by the computer system, the trained machine learning model using one or more evaluation criteria, wherein the one or more evaluation criteria comprise at least determining if an output of the machine learning model is within a threshold range of the pre-determined comprehensive vulnerability rating associated with the training dataset; receiving and normalizing, by the computer system, an inference dataset to generate a normalized inference dataset, wherein the inference dataset comprises information associated with at least one vulnerability; generating, by the computer system, one or more feature vectors from the normalized inference dataset; inputting, by the computer system, the one or more feature vectors to the trained machine learning model to generate a comprehensive vulnerability rating associated with the at least one vulnerability associated with the normalized inference dataset; receiving, by the computer system, computing system data, the computing system data comprising information associated with a plurality of computer devices; identifying, by the computer system, based on the comprehensive vulnerability rating associated with the at least one vulnerability associated with the normalized inference dataset, at least one computer device of the plurality of computer devices that is affected by the at least one vulnerability; displaying, by the computer system, via a user interface, the comprehensive vulnerability rating associated with the at least one vulnerability and the identified at least one computing device affected by the at least one vulnerability; wherein the computer system comprises a processor and a memory.

In some implementations, the method further comprises extracting features from the inference dataset using a large language model (LLM) to generate the normalized inference dataset.

In some implementations, generating the comprehensive vulnerability rating associated with the at least one vulnerability of the normalized inference dataset comprises determining a plurality of attributes associated with the at least one vulnerability and at least one or more logical relationships between the plurality of attributes. In some implementations, the plurality of attributes comprise at least one of the following: most recent exploitation date, number of threat actors, nationalities of threat actors, number of exploits, number of exploit codes, whether or not the at least one vulnerability has been weaponized, whether or not botnets are used to exploit the at least one vulnerability, whether or not the at least one vulnerability is associated with ransomware, a likelihood that the at least one vulnerability will be exploited in the near future, whether or not the at least one vulnerability has been reported by one or more tracking services, social media activity related to the at least one vulnerability, news reports related to the at least one vulnerability, particular types of malware associated with the at least one vulnerability, when the at least one vulnerability was first weaponized, when an exploit for the at least one vulnerability was first published, and whether or not a patch is available for the at least one vulnerability. In some implementations, the method further comprises determining a value associated with each of the plurality of attributes.

In some implementations, the machine learning model comprises a neural network. In some implementations, the machine learning model comprises a support vector machine algorithm, decision tree, Parzen window, Bayesian model, clustering model, reinforcement learning model, probability distribution, or decision tree forest. In some implementations, the machine learning model is locally hosted, cloud managed, accessed via one or more Application Programming Interfaces (“APIs”), or any combination of the above.

In some implementations, the method further comprises determining a score for each of the one or more feature vectors, wherein the score corresponds to a contribution of the feature vector to the comprehensive vulnerability rating associated with the at least one vulnerability of the normalized inference dataset.

In some implementations, the generating the one or more feature vectors from the normalized inference dataset comprises determining a variance of one or more features of the normalized inference dataset and removing at least one of the one or more features that have a determined variance above a pre-determined threshold.

### DETAILED DESCRIPTION

Although certain preferred implementations and examples are disclosed below, inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Organizations can face significant challenges when mitigating security vulnerabilities. There are many vulnerabilities within organizational networks, and organizations tend to have increasingly large numbers of devices. For example, organizations may have a large number of networked devices such as laptops, desktops, smartphones, servers, security cameras, medical equipment, manufacturing equipment, industrial control equipment, office equipment (e.g., copiers, scanners, fax machines, etc.), and so forth. Devices may include physical devices or virtual devices, such as virtual machines. Some devices can be under a high level of control by the organization, while other devices may be under limited control. For example, as remote work has increased, more employees, contractors, and other workers are using their own smartphones, laptops, etc., to perform work, access an organization's systems, and so forth. Organizations may have “bring your own device” policies that enforce some restrictions, such as requiring automatic updates to be turned on, requiring complex passwords and/or multi-factor authentication, requiring the use of mobile device management software, or requiring organizational data to be segregated from a user's personal data. Some devices can be physical infrastructure controlled by the organization, while other devices can be cloud devices offered by a third party cloud service provider.

Furthermore, organizations can have a large number of software configurations, applications, and so forth. Software applications can rely on third party packages and/or libraries. The interplay between different systems, software packages, libraries, use cases, and so forth can make it difficult to predict the effects of vulnerabilities and/or the effects of taking actions to mitigate vulnerabilities, such as installing patches, changing configurations, and so forth. Accordingly, extensive testing can be important in order to avoid unexpected outcomes that can disrupt an organization's operations. As a result, organizations can struggle to implement mitigation measures. For example, some estimates indicate that many organizations typically only address from about 5% to about 15% of new vulnerabilities each month.

The number of computer vulnerabilities and exposures (CVEs) (also referred to herein as vulnerabilities) has grown substantially over time. For example, the number of new CVEs grew from about 5,700 to more than 25,000 from 2009 to 2022. Some vulnerabilities can be highly impactful, for example because of the damage they can do to computing systems, potential interruption of an organization's operations, loss of data, and theft of data. Other vulnerabilities can be less impactful, for example because they are difficult to exploit, limited tools exist to exploit them, or they lack harmful features.

In some cases, a threat level can be defined based on various factors or attributes of a vulnerability. For example, the threat level can be impacted by the attack vector (e.g., access over a network generally, access over a local network (e.g., a local IP subnet), local access, or physical access), attack complexity (e.g., whether or not an attack can be reliably carried out using a particular procedure), privileges required (e.g., whether the attacker needs to obtain no permissions, low permissions (e.g., a limited user account), or high permissions (e.g., an administrator or root account)), whether or not a vulnerability exploit requires user interaction (e.g., opening a file, approving an access control request such as a UAC request, a sudo request, etc.), whether the vulnerability and/or exploit enables a change in scope, whether the vulnerability and/or exploit impacts confidential information, whether the vulnerability and/or exploit impacts data or system integrity, or whether the vulnerability and/or exploit impacts data or system availability.

In some cases, other factors can be considered additionally or alternatively, such as the maturity of exploit code, a remediation level (e.g., whether or not there is a fix or workaround for a vulnerability), and confidence in reports about the vulnerability and/or exploits.

Assigning threat levels can be difficult for a variety of reasons. Malicious actors are constantly using new techniques and strategies to exploit vulnerabilities. Novel attack vectors and continuous development of malware can make it challenging to accurately predict the impact of a vulnerability.

Some traditional approaches to determining threat levels rely on rigid formulas or can otherwise lack flexibility. For example, the Common Vulnerability Scoring System Calculator (CVSSC) base score is defined by a strict mathematical equation for determining a vulnerability score. A common vulnerability scoring system (CVSS) 3.1 base score, for example, is defined in terms of an impact subscore and an exploitability subscore, where the impact subscore is a function of confidentiality impact, integrity impact, and availability impact, and the exploitability subscore is a function of attack vector, attack complexity, required privileges, and user interaction requirements.

CVSS scores are used to quantify the overall severity and impact of a vulnerability. A CVSS score is based on the properties of the vulnerability itself. However, CVSS scores alone offer little insight into whether or not a vulnerability will actually be exploited. For example, one study found that when CVEs with a CVSS base score of 7 or above were prioritized for remediation, there was a significant false positive rate. That is, a large number of prioritized vulnerabilities were not exploited within the next 30 days. Moreover, many exploits that were not prioritized were nonetheless exploited.

The exploitability prediction scoring system (EPSS) is another effort to measure exploitability of vulnerabilities. Specifically, EPSS attempts to estimate the probability of observing an exploitation of a vulnerability within the next 30 days. EPSS scores are most useful when there is no other evidence of exploitation. An EPSS score represents the calculated probability that a vulnerability will be exploited within the next 30 days. An EPSS percentile represents a relative ranking of exploit probabilities. For example, a particular vulnerability may have a probability of being exploited in the next 30 days of 10%, but as a majority of CVEs are never or rarely exploited in the wild, this can represent a high percentile ranking, e.g., about the 90th percentile. The EPSS model can provide valuable predictions. However, it is primarily useful in cases in which there is a lack of known exploit activity. The EPSS model can underrepresent exploit probabilities for actively exploited vulnerabilities. For example, if a vulnerability is under active exploit, the vulnerability's EPSS score may nonetheless be less than one.

EPSS percentiles represent a relative ranking of the likelihood that vulnerabilities are exploited. However, any given organization is unlikely to be vulnerable to every known exploit or every exploit included in the EPSS percentile calculations. Thus, reliance on EPSS percentiles alone can provide an inaccurate view of the vulnerabilities most likely to have an impact on an organization. Additionally, the EPSS model is designed to determine a probability of exploitation, without regard to the impact exploitation is likely to have on an organization. Thus, an EPSS score and/or EPSS percentile, without more, may provide limited insight into how vulnerabilities should be prioritized.

Thus, reliance on either CVSS scores or EPSS scores alone can result in poor prioritization of vulnerabilities for mitigation. As a result, an organization can expend significant resources working to mitigate vulnerabilities that are unlikely to be exploited, can fail to address some vulnerabilities that are likely to be exploited, and/or can fail to prioritize mitigation efforts effectively. Accordingly, there is a need for approaches that can accurately prioritize vulnerabilities for remediation by organizations.

In some cases, organizations can rely on a combination of CVSS and EPSS score data to prioritize mitigation activities. However, neither CVSS scores nor EPSS scores alone or in combination can provide a complete picture of the actual threat posed by any given vulnerability. In some cases, organizations can use CVSS scores, EPSS scores, and/or additional information to better prioritize mitigation activities.

In some cases, organizations can rely on rigidly defined formulas and/or logical relations to determine vulnerability mitigation priorities by calculating a comprehensive vulnerability rating. For example, a security provider and/or organization can specify one or more vulnerability attributes and values associated with the one or more attributes. For example and without limitation, an organization and/or security provider can prioritize vulnerability mitigation based one or more of how recently a vulnerability exploit was updated, a number of threat actors, nationalities of threat actors, number of exploits (e.g., number of times a vulnerability has been exploited), number of exploit codes (e.g., different scripts, applications, etc., that take advantage of the vulnerability), whether or not a vulnerability has been weaponized, whether or not botnets are used to exploit the vulnerability, whether or not the vulnerability is associated with ransomware, a likelihood that the vulnerability will be exploited in the near future (e.g., as determined via EPSS scores), whether or not a vulnerability has been reported by one or more tracking services, detected by one or more third party services and/or proprietary services (e.g., deception networks, reversing labs), social media activity related to the vulnerability, news reports related to the vulnerability, particular types of malware associated with the vulnerability, when a vulnerability was first weaponized, when an exploit for a vulnerability was first published, whether or not a patch is available for the vulnerability, and/or how long the patch, if available, has been available, a CISA due date, among others.

As just one example, a security provider and/or an organization may define rules such as “if (latest exploit update<=6 months AND number of threat actors>=1) OR minimum number of exploits>=11 OR is weaponized=True OR has botnets=True OR has ransomware=True or EPSS Score>=0.8 then comprehensive vulnerability rating=Critical.” While such rules can help prioritize mitigation actions, they can be rigid and may become less effective over time as the nature of vulnerabilities and/or exploits changes. It can be difficult to determine which attributes to include in such rules, which conditions (e.g., attributes and associated values) to specify for different attributes, and/or to determine how attributes should be logically connected.

In some cases, it can be significant to consider not just the vulnerability and/or exploits, but also other factors such as the entities being targeted (e.g., financial institutions, governments, high-ranking officials or executives, healthcare facilities, manufacturing facilities, individual users) and the threat actors carrying out attacks (e.g., whether or not groups exploiting a vulnerability are state-sponsored, located in a country with lax law enforcement, etc.). For example, a threat that is being exploited against municipal infrastructure can be a high priority for local governments and similar entities to address but may be a lower priority for other types of organizations, such as healthcare facilities.

As described herein, it can be difficult to determine formulas for comprehensive vulnerability ratings. In some cases, models such as artificial intelligence (AI) and machine learning (ML) models can be used to determine the most relevant attributes, to optimize values for the attributes, and/or to determine logical relationships between attributes. As used herein, the term “model” can include any one or a combination of computer-based AI and/or ML models of any type and of any level of complexity, such as any type of sequential, functional, or concurrent model. Models can further include various types of computational models, such as, for example, artificial neural networks (“NN”), language models (e.g., LLMs), AI models, ML models, multimodal models (e.g., models or combinations of models that can accept inputs of multiple modalities, such as images and text), and/or the like.

For example, a “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Other examples of models include neural networks, support vector machines, decision trees, Parzen windows, Bayes, clustering, reinforcement learning, probability distributions, decision trees, decision tree forests, and others. Models can be configured for various situations, data types, sources, and output formats. In various implementations, the one or more models of the present disclosure may be locally hosted, cloud managed, accessed via one or more Application Programming Interfaces (“APIs”), and/or any combination of the foregoing and/or the like. Additionally, in various implementations, the one or more models of the present disclosure may be implemented in or by electronic hardware such as computer processors.

In some implementations, a model can be used to determine comprehensive vulnerability ratings. In some implementations, a model can undergo supervised learning in which input data is labeled with comprehensive vulnerability ratings. In some implementations, attributes can be predetermined, and a model can be trained to optimize the values of the attributes. In some implementations, attributes can be predetermined, and a model can be trained to determine the relationships between attributes (e.g., logical relations such as AND, OR, XOR, etc.). In some implementations, the attributes may not be predefined/predetermined. For example, a model can be provided with multiple attributes, and the model can determine which attributes are most significant for determining comprehensive vulnerability ratings. In some implementations, a model can be provided with input data and labels and can be trained to output a comprehensive vulnerability rating. In some implementations, an LLM can be used in harvesting and determining risk and/or popularity labels.

Different approaches can impact the explainability of a comprehensive vulnerability rating. For example, if a model is configured to output attribute values for a set of defined attributes, the reasons for a particular vulnerability rating can be readily determined, as both the attributes and the values are known. If, however, a model is trained to produce a comprehensive vulnerability rating or similar metric as a final output, explainability can be reduced, as it may not be clear which attributes were most important in determining the comprehensive vulnerability rating or the relevant conditions, values, limits, etc., for different comprehensive vulnerability ratings.

In some implementations, explainability techniques can be used by the system to enhance explainability of model outputs. For example, the importance of different features can be determined by considering the activation of neurons in a neural network. Neuron activation can show links and dependencies between activated neurons. In some implementations, a system can be configured to determine a score for each feature that indicates the contributions of features to a model's output. In some implementations, a system can be configured to provide Shapley values. Shapley values can be significant because, for example, the attributes (features) used by a model may not be independent, which can make attributing the output of a model to features input into the model difficult. Various approaches can be used to compute Shapley values or approximations thereof. For example, some techniques include integrated gradients to produce Aumann-Shapley values and approximation of Shapley values through sampling. Explainability can be important, as otherwise organizations may lack confidence in the performance of a model configured to output comprehensive vulnerability ratings.

While identifying the most critical vulnerabilities is important, the comprehensive vulnerability ratings described above lack knowledge of and/or context about an organization's assets (e.g., endpoints, laptops, desktops, servers, smartphones, tablets, security cameras, operational technology systems, routers, switches, etc.), network structure, the information stored on those assets, the access controls in place for those assets, and so forth. It can be significant to identify vulnerable assets so that only affected assets are targeting for mitigation actions. In some implementations, contextual information can be used to prioritize mitigation actions.

Contextual information can be important to help prioritize assets on which to carry out mitigation actions. For example, if two assets (e.g., two servers) both are open to a particular vulnerability, but one of the servers is only accessible while on an internal corporate network while the other server is exposed to the internet, carrying out mitigation actions on the exposed server can be a higher priority. As another example, if the first server contains archives of public financial disclosures and the second contains data related to current internal research and development, the second server can be assigned a higher priority as the exfiltration of data that is already public can be less impactful than internal data related to current work.

In some implementations, a security platform can monitor an organization's assets, can maintain an inventory of the organization's assets, and so forth. For example, the security platform can maintain an inventory of an organizations that can include information such as, for example and without limitation, operating system, operating system version, operating system patch level, MAC address, IP address, installed software, installed software versions, active services, startup applications, scheduled applications/scripts/etc. (e.g., scheduled tasks, cron jobs, etc.). In some implementations, the inventory can include information such as type of data stored on or accessible by an asset, and criticality of the asset to the organization's operations, among others. In some implementations, administrators or other organization personnel can specify such contextual information. In some implementations, the security platform can include a network map that indicates the relationships between different assets, between assets and the internet, and so forth. For example, an organization can use different subnets, IP ranges, etc., to segment its network, some assets may be accessible over a local network while others can be accessible over the internet.

In some implementations, a model can be used for determining and/or analyzing contextual information. For example, in some embodiments, device information in a database can be used to evaluate the role and/or importance of a specific device and/or to estimate the correlation between connected devices (e.g., a database server can be in communication with a front end server and an application server).

The techniques described above with respect to determining comprehensive vulnerability ratings can be similarly applied to determining asset vulnerability ratings. In some implementations, contextual information can be an input or inputs to a model as described above, and the contextual information can be used to identify which assets are most vulnerable and/or to provide asset vulnerability ratings for an organization's assets.

In some implementations, a machine learning model can receive contextual information and comprehensive vulnerability ratings (for example as determined using the approaches described herein), and the model can be trained to provide asset vulnerability ratings. In some implementations, contextual information and comprehensive vulnerability ratings can be input data and asset vulnerability ratings can be labels, and the model can be trained using supervised learning.

As described herein, in some implementations, a computing system can be configured to determine features for use in determining comprehensive vulnerability ratings and/or determining asset vulnerability ratings. Various techniques can be used to select features. In some implementations, unsupervised feature selection, in which the output (e.g., comprehensive vulnerability rating or asset vulnerability rating) are not provided, can be used. For example, features can be dropped if they have variance below a threshold value in a dataset. In some implementations, features can be dropped if they have more than a threshold amount of missing values or portion of missing values (e.g., more than 10%, more than 20%, more than 30%, more than 40%, more than 50%, more than 60%, more than 70%, more than 80%, more than 90%, etc.). In some implementations, features can be dropped if there is a high correlation between features. For example, if a first feature is strongly correlated with a second feature, one of the first feature and the second feature can be dropped. When employing such approaches, however, it can be important to consider that many vulnerabilities may share attributes. For example, as discussed above, a majority of vulnerabilities are never actively exploited, and thus there can be little variance in a measure of vulnerability exploitation, yet the variance that does exist can be highly impactful and thus such a measure should not be dropped.

In some implementations, a model can be used to select features. For example, in some implementation, wrapper methods can be used to test different subsets of features and determine an optimal subset of features. In some implementations, backward selection can be used, in which a model initially comprises all available features, and in subsequent iterations, features are removed one at a time until a desired subset of features is obtained. In such an approach, the feature with the greatest impact on model performance can be removed for a subsequent run, and the process can be repeated until a desired subset comprising the removed features is obtained. In some implementations, forward selection can be used, in which features are added one by one until a desired model performance is obtained. In some implementations, a feature can be added, and model performance can be re-evaluated. If the added feature provides additional value (e.g., improves model performance) by at least a threshold amount, the added feature can be retained. In some implementations, recursive feature elimination can be used. Recursive feature elimination can operate in a similar manner as backward selection, except that instead of examining model performance, feature importance is extracted from the model. Feature importance can be determined by, for example, feature weights, impurity decrease, or permutation importance.

In some implementations, filters can be used to select features. For example, the statistical relation between a feature and the output of a model can be used to select features.

In some implementations, a machine learning model can include embedded feature selection. As just one example of such an approach, the LASSO regression operates much like a linear regression, except that a loss function can reduce feature weights towards zero, resulting in some features having zero weight and thus effectively being removed from the machine learning model.

Explainability can be significant as organizations and IT professionals would often like to know the reasons behind particular ratings. Without such information, an organization may lack trust in the ratings, may face difficulty justifying certain actions or decisions not to take certain actions, and so forth.

### Machine Learning

In some implementations, a model (e.g., a comprehensive vulnerability rating model or asset vulnerability rating model) can be a neural network with multiple input nodes that receive input data such as vulnerability information, asset information, etc. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used as or to determine a comprehensive vulnerating rating, asset vulnerability rating, etc. In some implementations, such neural networks, known as deep neural networks, can have multiple layers of intermediate nodes with different configurations, can be a combination of models that receive different parts of the input and/or input from other parts of the deep neural network, or are convolutions-partially using output from previous iterations of applying the model as further input to produce results for the current input.

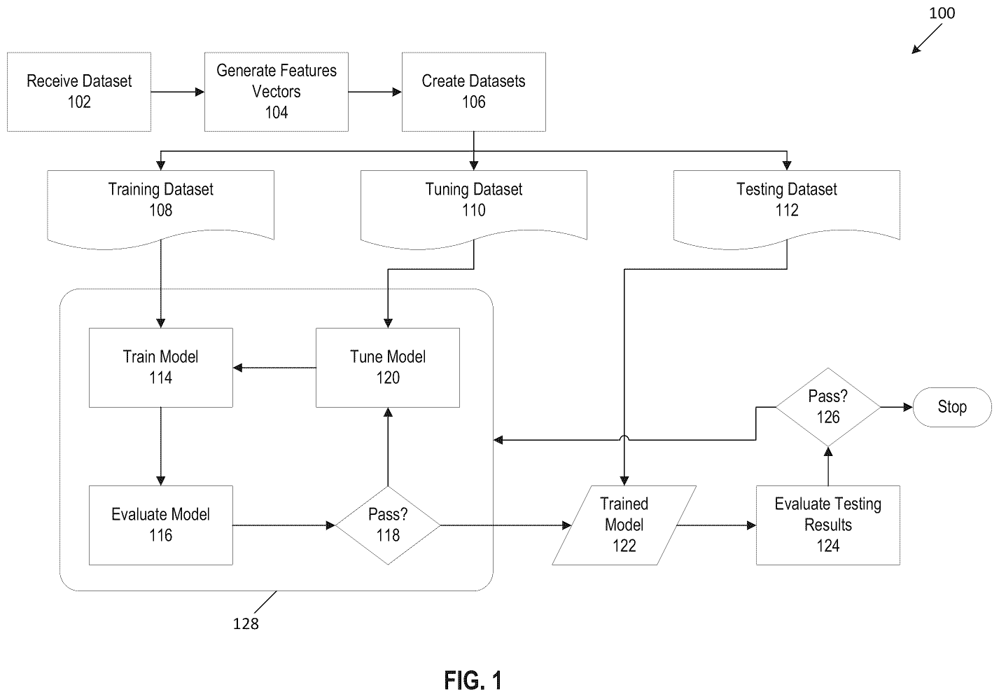

FIG. 1 depicts an example of a process in a flow diagram for training an artificial intelligence or machine learning model. The process 100 can be performed on a computing system. Various embodiments of such a process for training an AI or ML model can include additional features and/or can exclude certain illustrated features (for example, when a transformed/preprocessed dataset is received such that “apply transformations” in block 832 does not need to be performed.)

As illustrated in the example of FIG. 1, at block 102 the system receives a dataset. At block 104, one or more transformations may be performed on the data in the dataset to generate feature vectors. In an example, data may require transformations to conform to expected input formats to conform with expected formatting, e.g., date formatting, units (e.g., pounds vs kilograms, Celsius vs Fahrenheit, inches vs centimeters, etc.), be of a consistent format, and the like. In some embodiments, the data may undergo conversions to prepare it for use in training an AI or ML algorithm, for example, categorical data may be encoded in a particular manner. In some embodiments, nominal data may be encoded using one-hot encoding, binary encoding, feature hashing, or other suitable encoding methods. In some embodiments, ordinal data may be encoded using ordinal encoding, polynomial encoding, Helmert encoding, and so forth. In some embodiments, numerical data may be normalized, for example by scaling data to a maximum of 1 and a minimum of 0 or −1. In some embodiments, a dataset can include images, and the images can undergo resizing, orienting, color correction;, color space transformations, and so forth. These are merely examples, and the skilled artisan will readily appreciate that other transformations are possible.

At block 106, the system can generate training, tuning, and testing/validation datasets. In some embodiments, the training dataset 108 may be used during training to determine features for forming model that can be used for prediction, classification, and so forth. In some embodiments, the tuning dataset 110 may be used to select final models (e.g., final model weights) and to prevent or correct overfitting that may occur during training with the training dataset 108, which can otherwise lead to poor generalization of the model. In some embodiments, the testing dataset 112 may be used after training and tuning to evaluate the model. For example, in some embodiments, the testing dataset 112 may be used to check if the model is overfitted to the training dataset. For example, when iterative training is used, overfitting can be indicated by continued improvement in the model performance on training data (e.g., the loss function or error continues to improve) while performance on a testing dataset improves for some period of time or number of training iterations, but then starts to decrease.

In some embodiments, the system, in training loop 128, may train the model at block 114 using the training dataset 108. In some embodiments, training may be conducted in a supervised, unsupervised, or partially supervised manner. In some embodiments of the present disclosure, supervised training may be used. At operation 116, in some embodiments, the system may evaluate the model according to one or more evaluation criteria. For example, in some embodiments, the evaluation may include determining how well the model outputs match pre-determined comprehensive vulnerability ratings, asset vulnerability ratings, etc. At operation 118, in some embodiments, the system may determine if the model meets the one or more evaluation criteria. In some embodiments, if the model fails evaluation, the system may, at operation 120, tune the model using the tuning dataset 110, repeating the training 114 and evaluation 116 until the model passes the evaluation at operation 118. In some embodiments, once the model passes the evaluation at operation 118, the system may exit the model training loop 128. In some embodiments, the testing dataset 112 may be run through the trained model 122 and, at operation 124, the system may evaluate the results. In some embodiments, if the evaluation fails, at operation 126, the system may reenter training loop 128 for additional training and tuning. If the model passes at operation 126, the system may stop the training process, resulting in a trained model 122. In some embodiments, the training process may be modified. For example, in some embodiments, the system may not use a tuning dataset 110. In some embodiments, the model may not use a testing dataset 112.

In some embodiments, testing can be performed within training loop 128, and training can be stopped once improvement in the model's performance on testing data stops improving or starts to decrease. For example, training can stop to avoid overfitting the model to the training data.

In some embodiments, a model can undergo periodic or continuous training. For example, a model can be updated as new information about vulnerabilities, assets, etc., becomes available. In some embodiments, the performance of an updated model can be compared with the performance of a current model. In some embodiments, if the performance of the updated model is better than the performance of the current model (e.g., higher true positive rate, lower false positive rate, higher true negative rate, lower false negative rate, etc.), the updated model can be used in place of the current model. If the updated model is not better than or is worse than the current model, the updated model may not be used.

In some embodiments, a machine learning model can be trained using supervised learning, where the training data includes input data such as attributes and values used for evaluation asset vulnerability ratings, comprehensive vulnerability ratings, etc., as input and a desired output, such as comprehensive vulnerability ratings and/or asset vulnerability ratings. A representation of the input can be provided to the model, for example as encoded feature vectors. Output from the model can be compared to the desired output (e.g., to the labels associated with the input data). For example, in a classification model, the desired output can be the true classification of the input, which can be compared with a classification determined by the model. In some embodiments, based on the comparison, the model can be modified, such as by changing weights associated with nodes of the neural network or parameters of the functions used at each node in the neural network (e.g., applying a loss function). The model can be modified until it produces the desired with a desired accuracy.

### Example Implementations

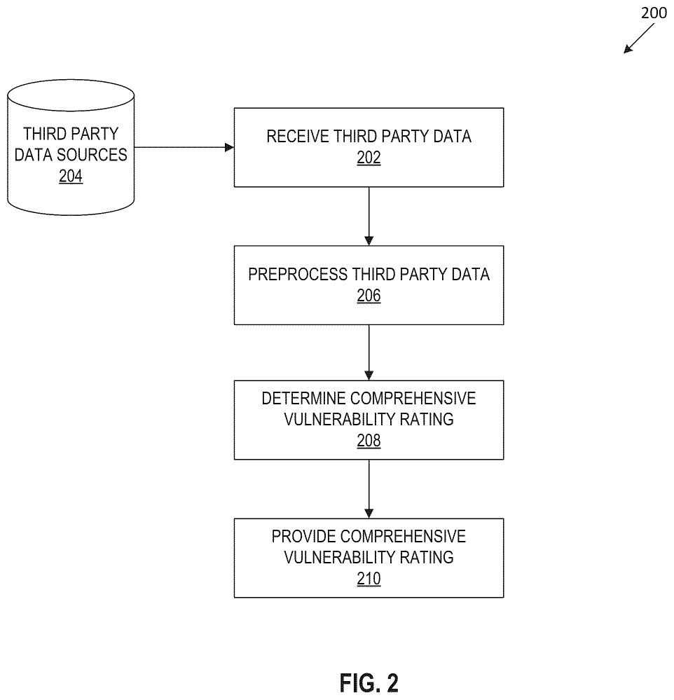

FIG. 2 is a diagram that illustrates an example process for determining comprehensive vulnerating ratings according to some implementations. The process 200 can be carried out on a computing system. At operation 202, the system can receive third party data from third party data sources 204. The third party data can include security threat information, such as information published by NIST, CVSS scores, National Vulnerability Database (NVD) data, news articles regarding vulnerabilities and/or exploits, social media activity, regarding vulnerabilities and/or exploits, virus scan data, etc. At operation 206, the system can preprocess the third party data, for example to convert the third party data to standardized formats, extract information from news articles, etc. In some implementations, some processing of third party data can be carried out using a large language model (LLM). For example, a news article can be submitted to an LLM to determine a summary of the news article and/or to extract key terms from the news article. At operation 208, the system can determine a comprehensive vulnerability rating for a vulnerability, for example using a machine learning model. The input data can be included in feature vectors as described herein. At operation 210, the system can provide the comprehensive vulnerability rating, for example by presenting the comprehensive vulnerability rating on a dashboard, in an email digest, and so forth. While discussed in terms of a single vulnerability, it will be appreciated that information can be processed about a plurality of vulnerabilities and a plurality of comprehensive vulnerability ratings can be produced.

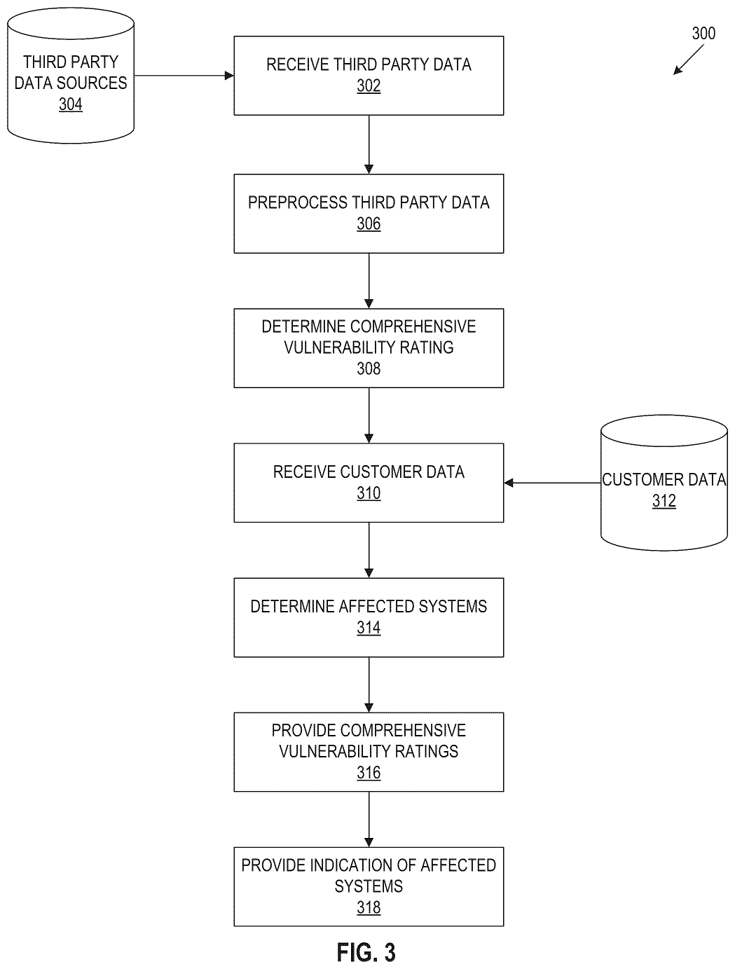

FIG. 3 illustrates an example process for determining comprehensive vulnerability ratings and identifying affected assets according to some implementations. The process 300 can be carried out on a computing system. At operation 302, the system can receive third party data from one or more third party data sources 304. At operation 306, the system can preprocess the third party data. At operation 308, the system can determine a comprehensive vulnerability rating for one or more security vulnerabilities, for example using a machine learning model as described herein. At operation 310, the system can receive customer data 312. The customer data can include, for example, information about computing systems and/or other hardware, information about the network structure of the customer, etc. At operation 314, the system can determine, based on the received customer data, which of the customer's systems are affected by the one or more vulnerabilities. At operation 316, the system can provide the comprehensive vulnerability ratings to the customer. At operation 318, the system can provide an indication of affected systems to the customer.

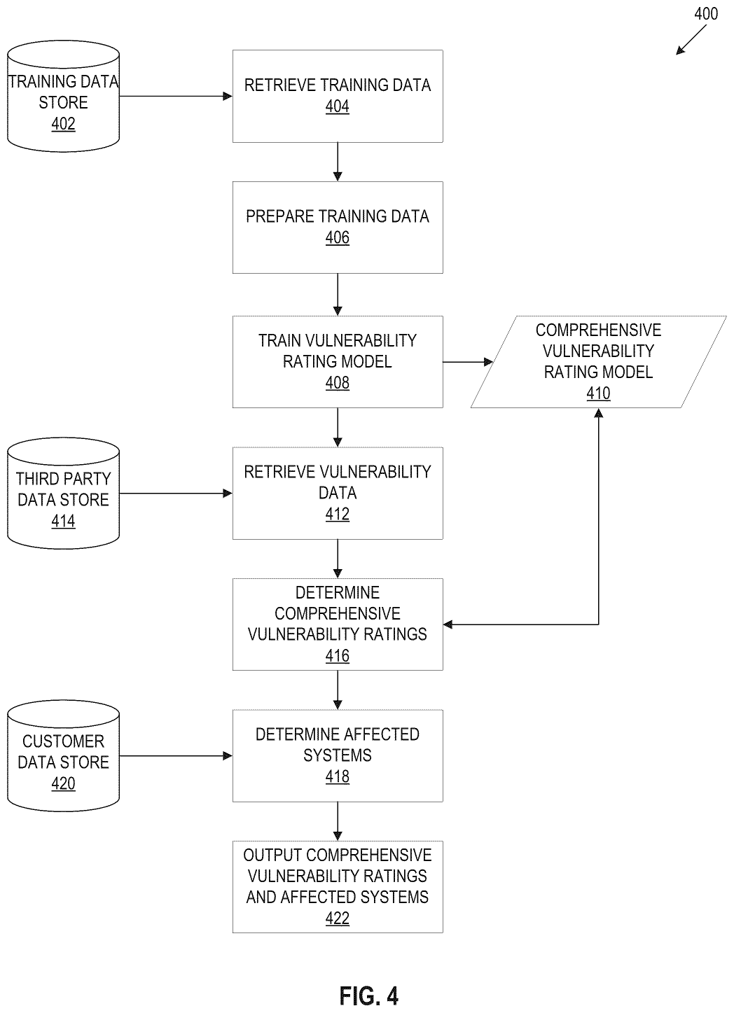

FIG. 4 is a diagram that illustrates an example process for training a machine learning model to determine comprehensive vulnerability ratings and using said model to determine comprehensive vulnerability ratings according to some implementations. The process 400 can be carried out on a computing system.

The process 400 can be implemented in various ways as described herein. In some implementations, a model can be trained to identify attributes and associated values in training data. In some implementations, attributes can be predetermined, and the model can be trained to determine associated values. In some embodiments, the model can determine comprehensive vulnerability ratings without exposing attributes, values, or both to the user. In some implementations, a model can use one or more feature selection approaches as described herein to determine attributes.

At operation 404, the system can receive training data from training data store 402. At operation 406, the system can prepare the training data, for example to normalize numerical values, convert text values to numerical values, standardize dates, and so forth. In some implementations, training data in data store 402 can be preprocessed and the data preparation at operation 406 can be omitted. At operation 408, the system can train the vulnerability ranking model, for example as described in more detail herein. For example, features can be encoded into vectors and provided to the machine learning model. The result of the training at operation 408 can be comprehensive vulnerability rating model 410.

In deployment, the system can retrieve vulnerability data at operation 412 from one or more third party data stores 414. The one or more third party data stores 414 can include information such as, for example, EPSS score, EPSS percentile, CVSS score, number of exploits, latest exploit update, first exploit publish data, first weaponized exploit publish date, whether or not an exploit or vulnerability has been weaponized, whether or not there is ransomware associated with the exploit, whether or not there is a botnet associated with the exploit, number of threat actors, names of threat actors, MITRE ID, CISA due date, whether the exploit has been reported to one or more tracking services (e.g., Google Project Zero), whether recent and/or new samples of exploit variants were seen by antivirus vendors and/or deception networks, etc. In some implementations, the data can include tags such as the names of threat actors, malware names, malware types, countries where threat actors are located, etc. In some implementations, information can include a type of organization targeted (e.g., financial services, healthcare, manufacturing, utilities, etc.). In some implementations, the data can include antivirus detection trends (e.g., detection rate, detection cadence (e.g., whether detections slowing down or speeding up), and so forth.

At operation 416, the system can determine comprehensive vulnerability ratings for one or more vulnerabilities using the comprehensive vulnerability model 410. At operation 418, the system can determine affected systems appearing in customer data store 420. The customer data store 420 can store information about systems in use by customers (e.g., operating system, installed software, exposed ports, processor make, processor model, etc.). At operation 422, the system can output the vulnerability rankings and the affected systems. In some implementations, a system may not be configured to determine affected systems, in which case operation 418 can be skipped and, at operation 422, the system can output vulnerability rankings but may not output an indication of affected systems.

As discussed above, in addition or alternatively to determining comprehensive vulnerability ratings, it can be important to provide asset vulnerability ratings that can be used to prioritize mitigation of issues on specific assets controlled by an organization.

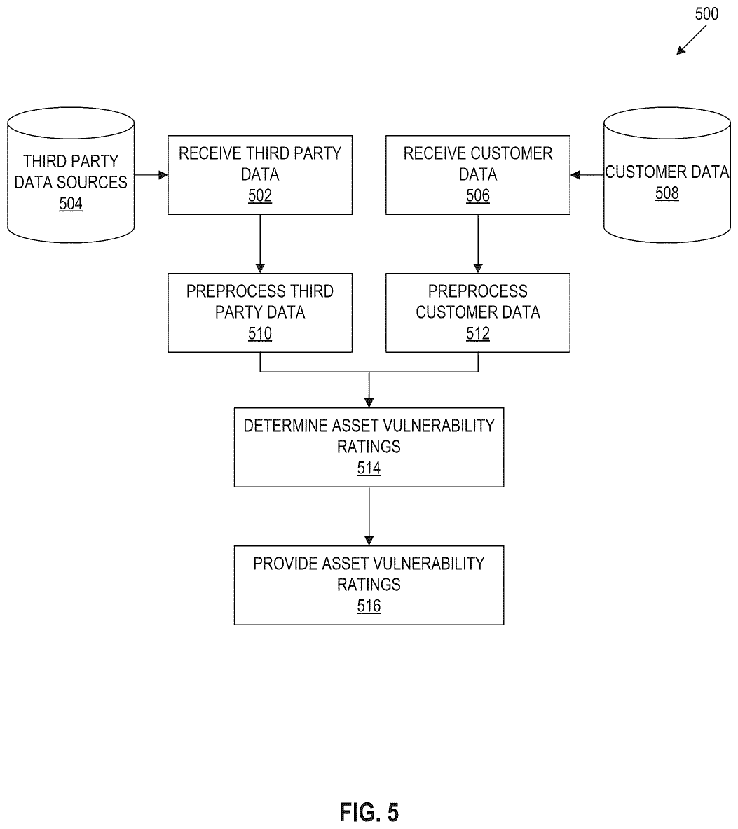

FIG. 5 illustrates an example process for determining asset vulnerability ratings according to some implementations. The process 500 can be carried out on a computing system. At operation 502, the computing system can receive third party data from one or more third party data sources 504. At operation 506, the system can receive customer data from a customer data source 508. The customer data can include information about a customer's assets, such as operating system, operating system version, active services, patch level, installed software, startup applications, network exposure (e.g., whether the asset is exposed to the internet, network file share information, information about other assets on a same network, subnet, etc., and so forth). At operation 510, the system can preprocess the third party data. At operation 512, the system can preprocess the customer data. At operation 514, the system can determine a asset vulnerability ratings based on the third party data and the customer data, for example using a machine learning model. At step 516, the system can provide an asset vulnerability rating for one or more assets to the customer.

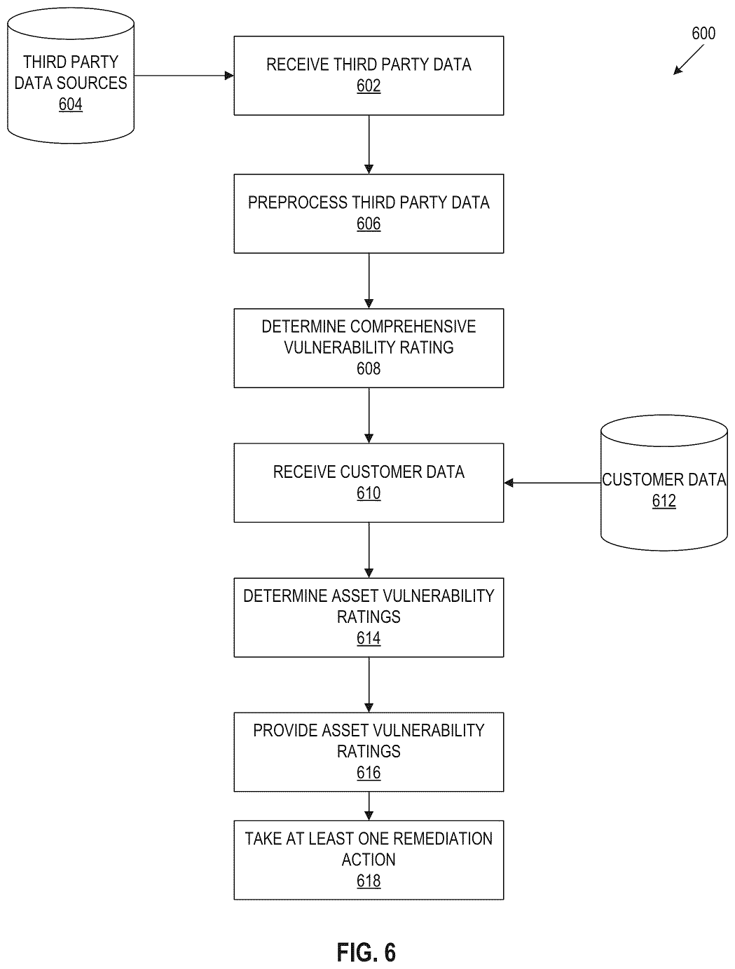

FIG. 6 is a block diagram illustrating an example process determining asset vulnerability ratings according to some implementations. The process 600 can be carried out on a computing system. At operation 602, the computing system can receive third party data from one or more third party data sources. At operation 606, the computing system can preprocess the third party data. At operation 608, the computing system can determine one or more comprehensive vulnerability ratings for one or more vulnerabilities, for example using a machine learning model as described herein. At operation 610, the computing system can receive customer data from a customer data store 612. At operation 614, the computing system can determine asset vulnerability ratings for one or more assets. For example, at operation 614, the computing system can use comprehensive vulnerability ratings and the customer data to determine asset vulnerability ratings for one or more assets. At operation 616, the computing system can provide the asset vulnerability ratings. At operation 618, the computing system can take at least one remediation action for at least one asset. The at least one remediation action can include, for example, applying a software patch, reducing or eliminating network access for the at least one asset, and so forth. In some implementations, the at least one remediation action can include providing a notification to an organization (e.g., to IT personnel) indicating that the asset has a particular asset vulnerability rating. In some implementations, remediation actions can be performed if the asset vulnerability rating is at or above a threshold value (e.g., asset vulnerability ratings of high or greater, asset vulnerability ratings of critical).

In any implementations described herein, comprehensive vulnerability ratings, asset vulnerability ratings, or both can be determined using a machine learning model. In any implementations described herein, comprehensive vulnerability ratings, asset vulnerability ratings, or both can be determined using one or more formulas. In some implementations, one or more machine learning models can be used to define or to partially define a formula, for example to provide attributes included in the formula, logical operations between conditions in a formula, and/or values for attributes in a formula. In some implementations, a machine learning model can provide default attributes, default attribute values, or both. In some implementations, users can customize the attributes, the attribute values, or both. In some implementations, users can customize logical relationships between conditions.

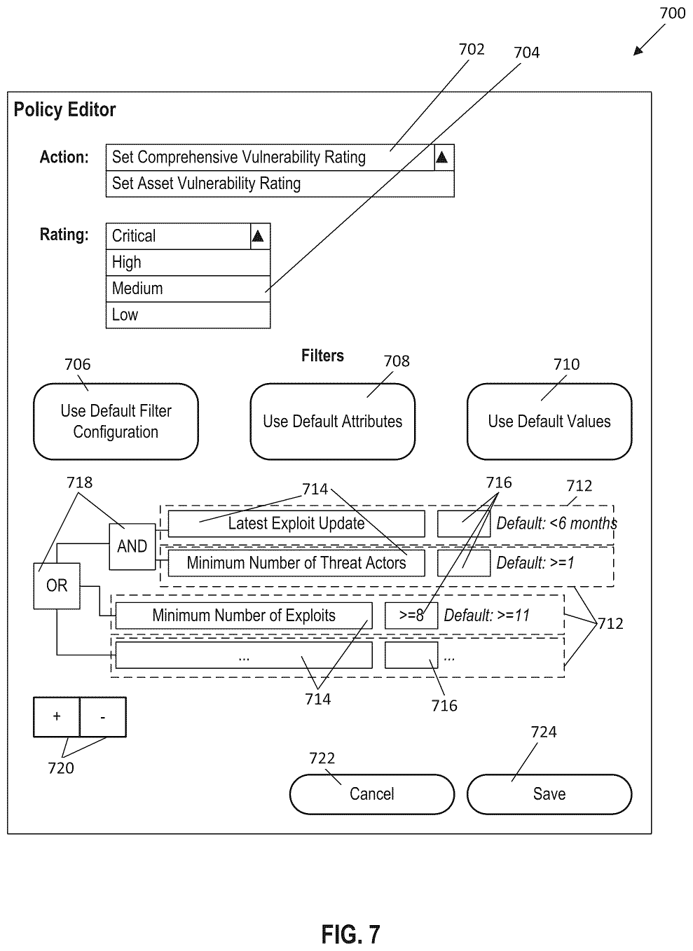

FIG. 7 illustrates an example user interface that can be used to define and/or customize one or more policies (e.g., comprehensive vulnerability ratings and/or asset vulnerability ratings). The user interface 700 can include a dropdown 702 for selecting a policy action (e.g., set comprehensive vulnerability rating, set asset vulnerability rating, etc.). The user interface 700 can include a dropdown 704 for selecting a rating for a policy (e.g., low, medium, high, critical, etc.). The user interface 700 can include a button 706 that can cause the policy editor to use a default filter configuration. The default filter configuration can be partially or fully determined by one or more machine learning models as described herein. The user interface 700 can include a button 708 that can cause the policy editor to use default attributes, but values, logical relationships, etc., may not be defined. The user interface 700 can include a button 710 that causes the policy editor to apply default values, for example as determined by a machine learning model as described herein.

A policy can include one or more conditions 712. Each condition can have an attribute 714 and a value 716 associated with the attribute. In some implementations, one or more default values can be available for one or more attributes. In some implementations, a default value can be used unless a user enters a value into value input 716. The one or more conditions 712 can be connected by logical relations 718. In some implementations, the user can customize the logical relations 718. In some implementations, the user can add or remove conditions 712 using the buttons 720 provided by the user interface 700. The user interface 700 can include a cancel button 722 that causes changes to be discarded and a save button 724 that can be used to save the policy.

### Computer System

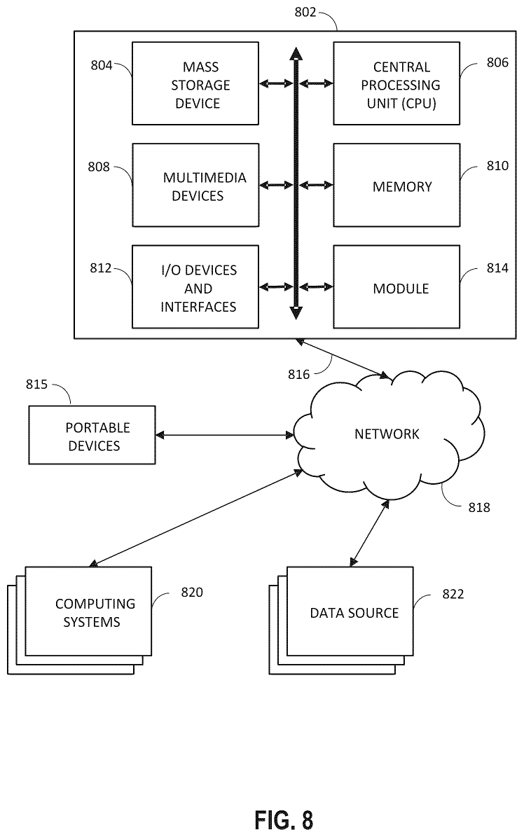

FIG. 8 is a block diagram 800 depicting an embodiment of a computer hardware system 802 configured to run software for implementing for implemented one or more of the systems and methods described herein. The example computer system 802 is in communication with one or more computing systems 820 and/or one or more data sources 822 via one or more networks 818. While FIG. 8 illustrates an embodiment of a computing system 802, it is recognized that the functionality provided for in the components and modules of computer system 802 may be combined into fewer components and modules, or further separated into additional components and modules.

The computer system 802 can comprise a module 814 that carries out the functions, methods, acts, and/or processes described herein. The module 814 is executed on the computer system 802 by a central processing unit 806 discussed further below.

In general, the word “module,” as used herein, refers to logic embodied in hardware or firmware or to a collection of software instructions, having entry and exit points. Modules are written in a program language, such as JAVA, C or C++, PYTHON, or the like. Software modules may be compiled or linked into an executable program, installed in a dynamic link library, or may be written in an interpreted language such as BASIC, PERL, LUA, or PYTHON. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 802 includes one or more processing units (CPU) 806, which may comprise a microprocessor. The computer system 802 further includes a physical memory 810, such as random-access memory (RAM) for temporary storage of information, a read only memory (ROM) for permanent storage of information, and a mass storage device 804, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 802 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 802 includes one or more input/output (I/O) devices and interfaces 812, such as a keyboard, mouse, touch pad, and printer. The I/O devices and interfaces 812 can include one or more display devices, such as a monitor, which allows the visual presentation of data to a user. More particularly, a display device provides for the presentation of GUIs as application software data, and multi-media presentations, for example. The I/O devices and interfaces 812 can also provide a communications interface to various external devices. The computer system 802 may comprise one or more multi-media devices 808, such as speakers, video cards, graphics accelerators, and microphones, for example.

The computer system 802 may run on a variety of computing devices, such as a server, a Windows server, a Structure Query Language server, a Unix Server, a personal computer, a laptop computer, and so forth. In other embodiments, the computer system 802 may run on a cluster computer system, a mainframe computer system and/or other computing system suitable for controlling and/or communicating with large databases, performing high volume transaction processing, and generating reports from large databases. The computing system 802 is generally controlled and coordinated by an operating system software, such as z/OS, Windows, Linux, UNIX, BSD, SunOS, Solaris, MacOS, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 802 illustrated in FIG. 8 is coupled to a network 818, such as a LAN, WAN, or the Internet via a communication link 816 (wired, wireless, or a combination thereof). Network 818 communicates with various computing devices and/or other electronic devices, such as portable devices 815. Network 818 is communicating with one or more computing systems 820 and one or more data sources 822. The module 814 may access or may be accessed by computing systems 820 and/or data sources 822 through a web-enabled user access point. Connections may be a direct physical connection, a virtual connection, and other connection type. The web-enabled user access point may comprise a browser module that uses text, graphics, audio, video, and other media to present data and to allow interaction with data via the network 818.

Access to the module 814 of the computer system 802 by computing systems 820 and/or by data sources 822 may be through a web-enabled user access point such as the computing systems' 820 or data source's 822 personal computer, cellular phone, smartphone, laptop, tablet computer, e-reader device, audio player, or another device capable of connecting to the network 818. Such a device may have a browser module that is implemented as a module that uses text, graphics, audio, video, and other media to present data and to allow interaction with data via the network 818.

The output module may be implemented as a combination of an all-points addressable display such as a cathode ray tube (CRT), a liquid crystal display (LCD), a plasma display, or other types and/or combinations of displays. The output module may be implemented to communicate with interfaces 812 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 802 may comprise a physical or logical connection established between a remote microprocessor and a mainframe host computer for the express purpose of uploading, downloading, or viewing interactive data and databases on-line in real time. The remote microprocessor may be operated by an entity operating the computer system 802, including the client server systems or the main server system, an/or may be operated by one or more of the data sources 822 and/or one or more of the computing systems 820. In some embodiments, terminal emulation software may be used on the microprocessor for participating in the micro-mainframe link.

In some embodiments, computing systems 820 who are internal to an entity operating the computer system 802 may access the module 814 internally as an application or process run by the CPU 806.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 802 may include one or more internal and/or external data sources (for example, data sources 822). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 802 may also access one or more databases 822. The databases 822 may be stored in a database or data repository. The computer system 802 may access the one or more databases 822 through a network 818 or may directly access the database or data repository through I/O devices and interfaces 812. The data repository storing the one or more databases 822 may reside within the computer system 802.

### Conclusion

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A comprehensive vulnerability rating system comprising:
at least one hardware processor; and
at least one non-transitory memory storing instructions, which, when executed by the at least one hardware processor, cause the system to:
receive and normalize a dataset to generate a normalized dataset, wherein normalizing the dataset comprises encoding categorical data and nominal data of the dataset;
generate a training dataset from the normalized dataset, wherein the training dataset comprises training attributes used to generate a pre-determined comprehensive vulnerability rating associated with the training dataset;
train a machine learning model by inputting the training dataset to the machine learning model to generate a trained machine learning model;
evaluate the trained machine learning model using one or more evaluation criteria, wherein the one or more evaluation criteria comprise at least determining if an output of the machine learning model is within a threshold range of the pre-determined comprehensive vulnerability rating associated with the training dataset;
receive and normalize an inference dataset to generate a normalized inference dataset, wherein the inference dataset comprises information associated with at least one vulnerability;
generate one or more feature vectors from the normalized inference dataset;
input the one or more feature vectors to the trained machine learning model to generate a comprehensive vulnerability rating associated with the at least one vulnerability associated with the normalized inference dataset;
receive computing system data, the computing system data comprising information associated with a plurality of computer devices;
identify, based on the comprehensive vulnerability rating associated with the at least one vulnerability associated with the normalized inference dataset, at least one computer device of the plurality of computer devices that is affected by the at least one vulnerability; and
display, via a user interface, the comprehensive vulnerability rating associated with the at least one vulnerability and the identified at least one computing device affected by the at least one vulnerability.

2. The vulnerability rating system of claim 1, wherein the system is further caused to extract features from the inference dataset using a large language model (LLM) to generate the normalized inference dataset.

3. The vulnerability rating system of claim 1, wherein generating the comprehensive vulnerability rating associated with the at least one vulnerability of the normalized inference dataset comprises determining a plurality of attributes associated with the at least one vulnerability and at least one or more logical relationships between the plurality of attributes.

4. The vulnerability rating system of claim 3, wherein the plurality of attributes comprise at least one of the following: most recent exploitation date, number of threat actors, nationalities of threat actors, number of exploits, number of exploit codes, whether or not the at least one vulnerability has been weaponized, whether or not botnets are used to exploit the at least one vulnerability, whether or not the at least one vulnerability is associated with ransomware, a likelihood that the at least one vulnerability will be exploited in the near future, whether or not the at least one vulnerability has been reported by one or more tracking services, social media activity related to the at least one vulnerability, news reports related to the at least one vulnerability, particular types of malware associated with the at least one vulnerability, when the at least one vulnerability was first weaponized, when an exploit for the at least one vulnerability was first published, and whether or not a patch is available for the at least one vulnerability.

5. The vulnerability rating system of claim 3, wherein the system is further caused to determine a value associated with each of the plurality of attributes.

6. The vulnerability rating system of claim 1, wherein the machine learning model comprises a neural network.

7. The vulnerability rating system of claim 1, wherein the machine learning model comprises a support vector machine algorithm, decision tree, Parzen window, Bayesian model, clustering model, reinforcement learning model, probability distribution, or decision tree forest.

8. The vulnerability rating system of claim 1, wherein the machine learning model is locally hosted, cloud managed, accessed via one or more Application Programming Interfaces (“APIs”), or a combination of the above.

9. The vulnerability rating system of claim 1, wherein the system is further caused to determine a score for each of the one or more feature vectors, wherein the score corresponds to a contribution of the feature vector to the comprehensive vulnerability rating associated with the at least one vulnerability of the normalized inference dataset.

10. The vulnerability rating system of claim 1, wherein the generating the one or more feature vectors from the normalized inference dataset comprises determining a variance of one or more features of the normalized inference dataset and removing at least one of the one or more features that have a determined variance above a pre-determined threshold.

11. A computer-implemented method for generating a comprehensive vulnerability rating associated with at least one vulnerability, the computer implemented method comprising:
receiving and normalizing, by a computer system, a dataset to generate a normalized dataset, wherein normalizing the dataset comprises encoding categorical data and nominal data of the dataset;
generating, by the computer system, a training dataset from the normalized dataset, wherein the training dataset comprises training attributes used to generate a pre-determined comprehensive vulnerability rating associated with the training dataset;
training, by the computer system, a machine learning model by inputting the training dataset to the machine learning model to generate a trained machine learning model;
evaluating, by the computer system, the trained machine learning model using one or more evaluation criteria, wherein the one or more evaluation criteria comprise at least determining if an output of the machine learning model is within a threshold range of the pre-determined comprehensive vulnerability rating associated with the training dataset;
receiving and normalizing, by the computer system, an inference dataset to generate a normalized inference dataset, wherein the inference dataset comprises information associated with at least one vulnerability;
generating, by the computer system, one or more feature vectors from the normalized inference dataset;
inputting, by the computer system, the one or more feature vectors to the trained machine learning model to generate a comprehensive vulnerability rating associated with the at least one vulnerability associated with the normalized inference dataset;
receiving, by the computer system, computing system data, the computing system data comprising information associated with a plurality of computer devices;
identifying, by the computer system, based on the comprehensive vulnerability rating associated with the at least one vulnerability associated with the normalized inference dataset, at least one computer device of the plurality of computer devices that is affected by the at least one vulnerability; and
displaying, by the computer system, via a user interface, the comprehensive vulnerability rating associated with the at least one vulnerability and the identified at least one computing device affected by the at least one vulnerability;
wherein the computer system comprises a processor and a memory.

12. The computer-implemented method of claim 11, further comprising extracting features from the inference dataset using a large language model (LLM) to generate the normalized inference dataset.

13. The computer-implemented method of claim 11, wherein generating the comprehensive vulnerability rating associated with the at least one vulnerability of the normalized inference dataset comprises determining a plurality of attributes associated with the at least one vulnerability and at least one or more logical relationships between the plurality of attributes.

14. The computer-implemented method of claim 13, wherein the plurality of attributes comprise at least one of the following: most recent exploitation date, number of threat actors, nationalities of threat actors, number of exploits, number of exploit codes, whether or not the at least one vulnerability has been weaponized, whether or not botnets are used to exploit the at least one vulnerability, whether or not the at least one vulnerability is associated with ransomware, a likelihood that the at least one vulnerability will be exploited in the near future, whether or not the at least one vulnerability has been reported by one or more tracking services, social media activity related to the at least one vulnerability, news reports related to the at least one vulnerability, particular types of malware associated with the at least one vulnerability, when the at least one vulnerability was first weaponized, when an exploit for the at least one vulnerability was first published, and whether or not a patch is available for the at least one vulnerability.

15. The computer-implemented method of claim 13, further comprising determining a value associated with each of the plurality of attributes.

16. The computer-implemented method of claim 11, wherein the machine learning model comprises a neural network.

17. The computer-implemented method of claim 11, wherein the machine learning model comprises a support vector machine algorithm, decision tree, Parzen window, Bayesian model, clustering model, reinforcement learning model, probability distribution, or decision tree forest.

18. The computer-implemented method of claim 11, wherein the machine learning model is locally hosted, cloud managed, accessed via one or more Application Programming Interfaces (“APIs”), or any combination of the above.

19. The computer-implemented method of claim 11, further comprising determining a score for each of the one or more feature vectors, wherein the score corresponds to a contribution of the feature vector to the comprehensive vulnerability rating associated with the at least one vulnerability of the normalized inference dataset.

20. The computer-implemented method of claim 11, wherein the generating the one or more feature vectors from the normalized inference dataset comprises determining a variance of one or more features of the normalized inference dataset and removing at least one of the one or more features that have a determined variance above a pre-determined threshold.
